(19) United States
(12) Patent Application Publication
(10) Pub. No.: US 2012/0042552 A1
(43) Pub. Date: Feb. 23, 2012

(54) Method of fabricating diamond-emulating display frame structure and diamond-emulating display frame structure provided by the same

(75) Inventors: Wen-Hung Huang, New Taipei City (TW); Kuan-Cheng Hsieh, Keelung City (TW); Yi-Chung Chiu, Taoyuan City (TW); Chih-Ming Chu, Taipei City (TW)

(73) Assignee: Hannspree, Inc., New Taipei City (TW)

(21) Appl. No.: 13/137,188

(22) Filed: Jul. 27, 2011

(30) Foreign Application Priority Data
Aug. 17, 2010 (TW) 099127386

(51) Int. Cl. A47G 1/06; B23P 17/00

(52) U.S. Cl. 40/798; 29/527.2

(57) ABSTRACT

A method of fabricating diamond-emulating display frame structure and a diamond-emulating display frame structure provided by the same are provided. The method of fabricating diamond-emulating display frame structure of the present invention comprises: providing a display frame module and a decorative frame, wherein the display frame module has a connecting part, the decorative frame has plural concaves arranged in order and separated via plural partitions; forming a de-waxing layer on the partitions of the decorative frame; forming an adhesive layer on the decorative frame; forming a reflective material layer on the adhesive layer; removing the de-waxing layer; drying the decorative frame; and combining the decorative frame with the display frame module via the connecting part.

### CROSS REFERENCE TO RELATED APPLICATION

This application claims the benefits of the Taiwan Patent Application Serial Number 099127386, filed on Aug. 17, 2010, the subject matter of which is incorporated herein by reference.

### BACKGROUND OF THE INVENTION

1. Field of the Invention

The present invention relates to a method of fabricating diamond-emulating frame structure and a diamond-emulating frame structure provided by the same, more particularly, to a method of fabricating diamond-emulating display frame structure and a diamond-emulating display frame structure provided by the same.

2. Description of Related Art

According to the related arts, Taiwan issued patent no. 363240 disclosed a cosmetic case having a decorative region on the outer surface of the case, the decorative region has plural concaves regularly arranged, the concaves are coated with paillettes, sparkle gold powders or fluorescence powders by a physical or chemical method, and some decorative items (e.g. artificial diamond or diamond-emulating plastics) are received in the concaves respectively. Therefore, due to those paillettes, fluorescence powder, or the decorative items, the cosmetic case has an attractive exterior and attracts the consumers' attention. The sparkle gold powders or fluorescence powders coated on the surface of the concaves may serve as a base layer to load those decorative items and enhance the reflectivity of the decorative region. However, those sparkle gold powders or fluorescence powders may only serve as the base layer, and cannot possess decorative ability independently. Also, the image or light reflected by those sparkle gold powders or fluorescence powders is blurred.

The Taiwan issued patent no. 372960 disclosed a novel case structure of a notebook, which has decorated with patterned sparkle gold powders and decorative items and thus the outer appearance of the notebook can be more beautiful. Besides, in the case structure, a concave cavity is set and coated with sparkle gold powders or fluorescence powders to form a base layer for improving the reflectivity of the decorative items (e.g. artificial diamond or diamond-emulating plastics). However, those sparkle gold powders or fluorescence powders may only serve as the base layer, and cannot possess decorative ability independently. Also, the image or light reflected by those sparkle gold powders or fluorescence powders is blurred.

Therefore, it is desirable to provide an improved structure and a method providing the same that enable sparkle gold powders or fluorescence powders possessing decorative ability independently and obtains diamond-emulating visual effect from those sparkle gold powders or fluorescence powders to improve the external appearance of various items such as a case structure of a display.

### SUMMARY OF THE INVENTION

The object of the present invention is to provide a method of fabricating diamond-emulating display frame structure and a diamond-emulating display frame structure provided by the same, which utilize sparkle gold powder layer or pearl luster powder to enhance diamond-emulating ability.

The method of fabricating a diamond-emulating display frame structure of the present invention comprises:

providing a display frame module and a decorative frame, wherein the display frame module has a connecting part, the decorative frame has plural concaves arranged in order and separated via plural partitions;

forming a de-waxing layer on the partitions of the decorative frame;

forming an adhesive layer on the decorative frame;

forming a reflective material layer on the adhesive layer;

removing the de-waxing layer;

drying the decorative frame; and

combining the decorative frame with the display frame module via the connecting part.

The diamond-emulating display frame structure of the present invention comprises:

a display frame module;

a decorative frame having plural concaves and plural partitions arranged in order, a reflective material layer is located in the plural concaves; and

a decorative member made of a transparent material;

wherein the decorative frame locates on the display frame module, and the decorative member locates on the decorative frame and combines with the display frame module.

According to the diamond-emulating display frame structure of the present invention, the concave preferably has a curved shape.

According to the diamond-emulating display frame structure of the present invention, the concave preferably has a trapezoid shape.

According to the diamond-emulating display frame structure of the present invention, the reflective material layer is a sparkle gold powder layer.

According to the diamond-emulating display frame structure of the present invention, a particle size of a sparkle gold powder in the sparkle gold powder layer is in a range of 0.004 mm-3.0 mm.

According to the diamond-emulating display frame structure of the present invention, the reflective material layer is a pearl luster powder layer.

According to the diamond-emulating display frame structure of the present invention, a particle size of a pearl luster powder in the pearl luster powder layer is in a range of 3 μm-150 μm.

According to the diamond-emulating display frame structure of the present invention, the reflective material layer is a solution of a pearl luster powder.

According to the diamond-emulating display frame structure of the present invention, the reflective material layer is an aluminum electro-platted layer.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the diamond-emulating display frame structure of the present invention;

FIG. 2 is a sectional view of a portion of the diamond-emulating display frame structure of the first embodiment;

FIG. 3 is a cross-sectional view at line A-A′ of FIG. 2 of the first embodiment;

FIG. 4 is a cross-sectional view at line B-B′ of FIG. 2 of the first embodiment;

FIG. 5 is a cross-sectional view of the decorative frame of the first embodiment after removing the de-waxing layer; and

FIG. 6 is a sectional view of a portion of the diamond-emulating display frame structure of the second embodiment;

FIG. 7 is a cross-sectional view of the decorative frame of the second embodiment;

FIG. 8 is a sectional view of a portion of the diamond-emulating display frame structure of the third embodiment;

FIG. 9 is a cross-sectional view of the decorative frame of the third embodiment.

### DETAILED DESCRIPTION OF THE PREFERRED EMBODIMENT

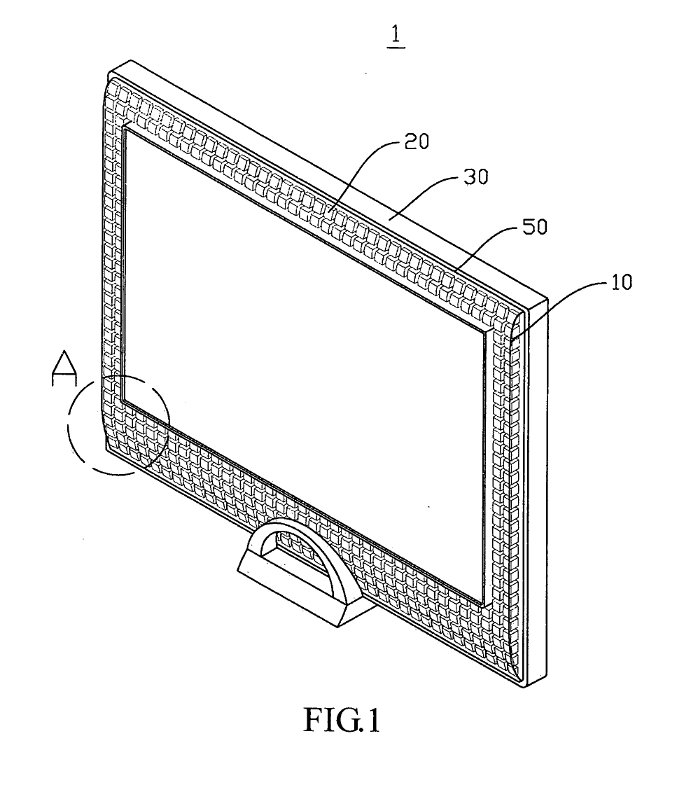

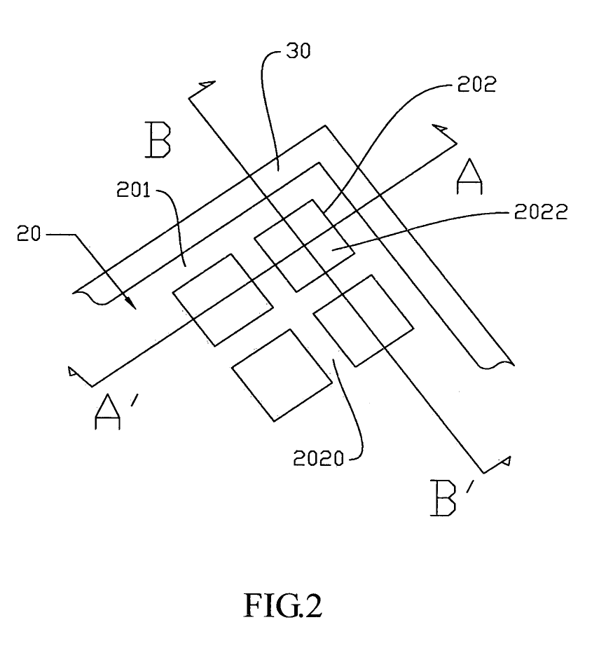

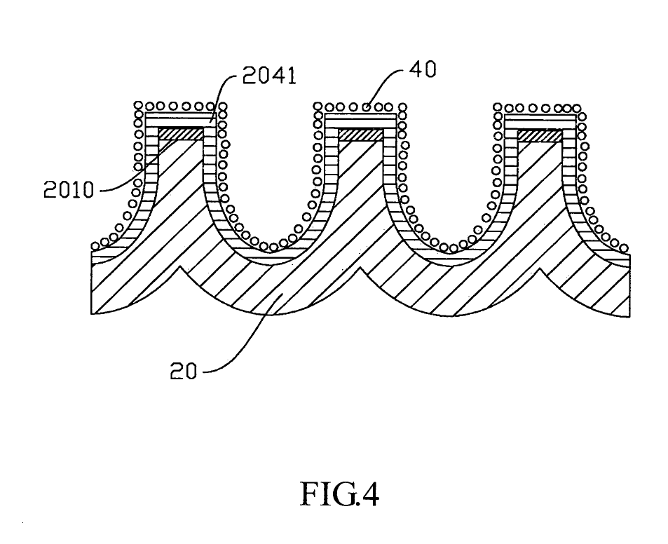

With reference to FIGS. 1, 2, 3, 4, and 5, the method of fabricating diamond-emulating display frame structure of the present invention comprises:

providing a display frame module 30 and a decorative frame 20, wherein the display frame module 30 has a connecting part 50, the decorative frame 20 has plural concaves 202 arranged in order and separated via plural partitions 2020;

forming a de-waxing layer 2010 on the partitions 2020 of the decorative frame 20;

forming an adhesive layer 2041 on the decorative frame 20;

forming a reflective material layer 40 on the adhesive layer 2041;

removing the de-waxing layer 2010;

drying the decorative frame 20; and

combining the decorative frame 20 with the display frame module 30 via the connecting part 50.

### First Embodiment

With reference to FIGS. 1, 2, 3, 4, and 5, a diamond-emulating display frame structure 1 of the present invention comprises: a display frame module 30; a decorative frame 20; and a decorative member 10.

First, a decorative frame 20 is provided, in which the decorative frame 20 has plural concaves 202 arranged in order and separated via plural partitions 2020. The concave 202 has a curved shape and thus forms a curved concave 2022.

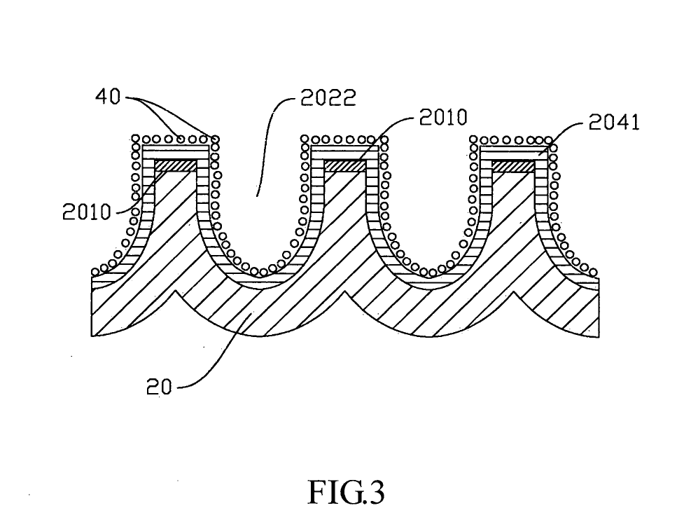

Then, a de-waxing layer 2010 is formed on the surface of the partitions 2020 of the decorative frame 20 by a screen printing method, and a de-waxing region 201 is thus formed between the curved concaves 2022, as shown in FIG. 3.

After that, an adhesive layer 2041 is spray coated on the whole surface of the decorative frame 20 that has printed with the de-waxing layer 2010, and then a reflective material layer 40 is spray coated on the surface of the decorative frame 20 that has coated with the adhesive layer 2041. Herein, the reflective material layer 40 is a sparkle gold powder layer.

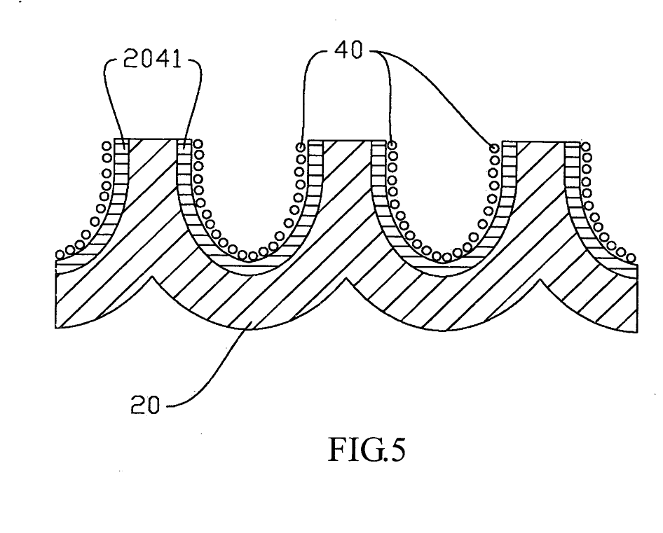

Last, part of the reflective material layer 40 that locates at the de-waxing region 201 is removed to expose the partitions 2020. Then, the decorative frame 20 is dried at a drying room, and the obtained decorative frame 20 is shown in FIG. 5.

Reference with FIG. 1, the decorative frame 20 that is coated with the reflective material layer 40 is combined with the display frame module 30, and then the decorative member 10 made of a transparent material is set on the decorative frame 20 and is fixed with the display frame module 30. Therefore, the diamond-emulating display frame structure of the present invention is able to enhance diamond-emulating visual effect without using other decorative items such as artificial diamond or diamond-emulating plastics.

In the present embodiment, the sparkle gold powder of the reflective material layer 40 can be a thermoplastic material made by vacuum-sputtering an aluminum layer on a base and following with dyeing and fine-cutting, in which the material of the base can be selected from polyethylene terephthalate (PET) and polyvinylchloride (PVC), the diameter (i.e. the particle size) of the base can be in a range of 0.004 mm-3.0 mm, the shape of the base can be square, hexagon, a heart-shape, a star-shape, a crescent-shape, or a snowflake-shape, and the color of the base can be gold, silver, multi-color (e.g. rainbow color or any color combination), or pearl luster.

### Second Embodiment

The diamond-emulating display frame structure of the second embodiment is similar with that of the first embodiment, except the curved concave 2022 is replaced with a trapezoid concave 2024 and the sparkle gold powder layer is replaced with a pearl luster powder layer having a smaller particle size.

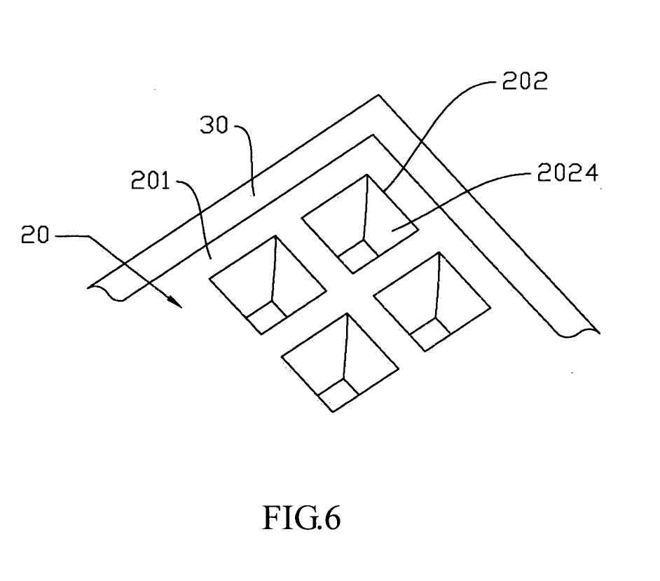

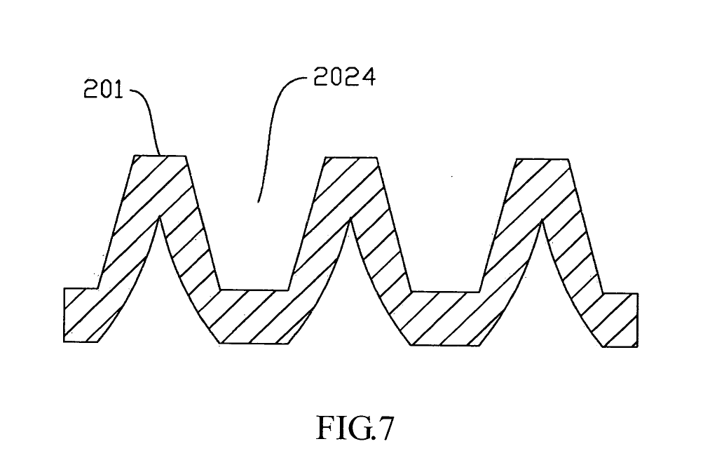

Reference with FIGS. 6 and 7, the trapezoid concave 2024 in the second embodiment has four inclined walls and a flat floor.

According to the second embodiment, the sparkle gold powder in the sparkle gold powder layer is a mica powder coated with titanium dioxide, which has a color of silver white, a density of 3 g/cm, and a particle size of in a range of 3 μm-150 μm.

In the second embodiment, the reflective material layer 40 can be selectively made of an aluminum sputtered layer for replacing the pearl luster powder layer.

### Third Embodiment

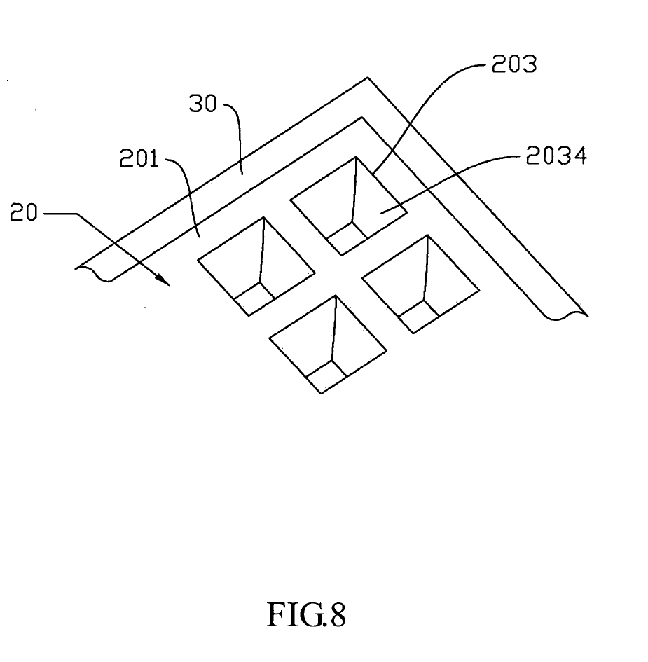

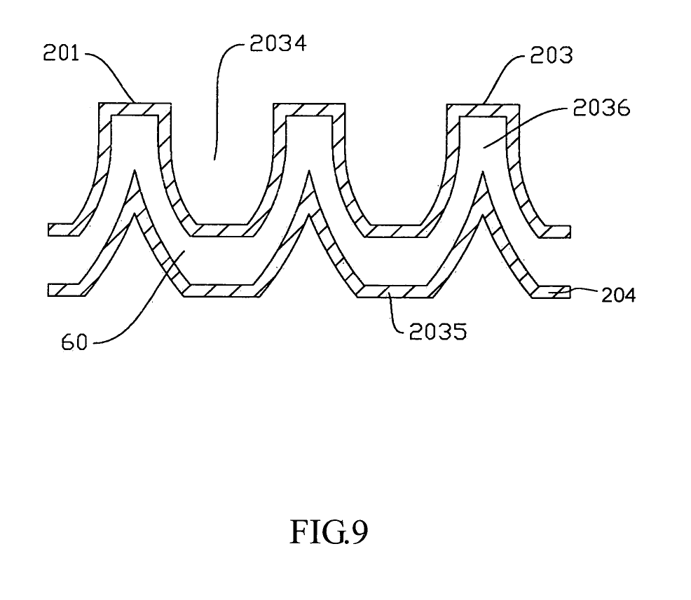

Reference with FIGS. 8 and 9, the diamond-emulating display frame structure of the third embodiment is shown, which has a first decorative sub-frame 203 and a second decorative sub-frame 204 coupling with each other, and thus a spacing 2036 is provided between the first decorative sub-frame 203 and the second decorative sub-frame 204. The first decorative sub-frame 203 is made of a transparent material. A solution layer 60 comprising pearl luster powder is filled in the spacing 2036 and flowing therein, and therefore a different visual effect can be obtained.

Herein, the particle size of the pearl luster powder of the solution layer 60 is smaller than that of the second embodiment. The walls of the upper concave 2034 and the lower concave 2035 are curved inclined walls.

As mentioned above, the method of fabricating diamond-emulating display frame structure and a diamond-emulating display frame structure provided by the same of the present invention utilize sparkle gold powder layer or pearl luster powder as well as reflections at different angels from the display frame to enhance diamond-emulating visual effect without using other decorative items such as artificial diamond or diamond-emulating plastics. Therefore, the manufacturing cost of the diamond-emulating display frame structure can be largely decreased.

Although the present invention has been explained in relation to its preferred embodiment, it is to be understood that many other possible modifications and variations can be made without departing from the spirit and scope of the invention as hereinafter claimed.

What is claimed is:

1. A method of fabricating diamond-emulating display frame structure, comprising the following steps:
providing a display frame module and a decorative frame, wherein the display frame module has a connecting part, the decorative frame has plural concaves arranged in order and separated via plural partitions;
forming a de-waxing layer on the partitions of the decorative frame;
forming an adhesive layer on the decorative frame;
forming a reflective material layer on the adhesive layer;
removing the de-waxing layer;
drying the decorative frame; and
combining the decorative frame with the display frame module via the connecting part.

2. A diamond-emulating display frame structure, comprising:
a display frame module;
a decorative frame having plural concaves and plural partitions arranged in order, a reflective material layer is located in the plural concaves; and
a decorative member made of a transparent material;
wherein the decorative frame locates on the display frame module, and the decorative member locates on the decorative frame and combines with the display frame module.

3. The diamond-emulating display frame structure as claimed in claim 2, wherein the concave has a curved shape.

4. The diamond-emulating display frame structure as claimed in claim 2, wherein the concave has a trapezoid shape.

5. The diamond-emulating display frame structure as claimed in claim 2, wherein the reflective material layer is a sparkle gold powder layer.

6. The diamond-emulating display frame structure as claimed in claim 5, wherein a particle size of a sparkle gold powder in the sparkle gold powder layer is in a range of 0.004 mm-3.0 mm.

7. The diamond-emulating display frame structure as claimed in claim 2, wherein the reflective material layer is a pearl luster powder layer.

8. The diamond-emulating display frame structure as claimed in claim 7, wherein a particle size of a pearl luster powder in the pearl luster powder layer is in a range of 3 μm-150 μm.

9. The diamond-emulating display frame structure as claimed in claim 2, wherein the reflective material layer is a solution of a pearl luster powder.

10. The diamond-emulating display frame structure as claimed in claim 2, wherein the reflective material layer is an aluminum electro-platted layer.
